(19) United States
(12) Patent Application Publication
(10) Pub. No.: US 2024/0412914 A1
(43) Pub. Date: Dec. 12, 2024

(54) MAGNETIC ELEMENT

(71) Applicant: Delta Electronics, Inc., Taoyuan City (TW)

(72) Inventors: Han-Hsing Lin, Taoyuan City (TW); Tsung-Hsueh Wu, Taoyuan City (TW); Hsi-Kuo Chung, Taoyuan City (TW); Ruei-Wun Jhong, Taoyuan City (TW); Chun-Ping Chen, Taoyuan City (TW)

(21) Appl. No.: 18/384,123

(22) Filed: Oct. 26, 2023

(30) Foreign Application Priority Data
Jun. 8, 2023 (CN) 202310676301.5

(51) Int. Cl. H01F 27/02; H01F 27/255; H01F 27/28

(52) U.S. Cl. CPC H01F 27/022; H01F 27/255; H01F 27/2804; H01F 27/2823

(57) ABSTRACT

A magnetic element includes a first magnetic core, a coil and a second magnetic core. The first magnetic core is made of a ferrite material, and a magnetic permeability of the first magnetic core is higher than 700. The coil is installed on the first magnetic core. The second magnetic core is formed by molding an alloy composition. In addition, the coil and at least a portion of the first magnetic core are covered by the second magnetic core.

### CROSS-REFERENCE TO RELATED APPLICATION

This application claims priority to China Patent Application No. 202310676301.5, filed on Jun. 8, 2023. The entire contents of the above-mentioned patent application are incorporated herein by reference for all purposes.

### FIELD OF THE INVENTION

The present disclosure relates to a magnetic element, and more particularly to a magnetic element with two magnetic cores made of different materials.

### BACKGROUND OF THE INVENTION

Recently, with the increasing growth of the global telecommunication industry, communication power supplies are developed at increasing rate in developing regions such as Asia-Pacific region and Africa. In order to cope with the increasing data flow and the emerging business demands, it is necessary to build communication base stations, telecommunication apparatuses and network infrastructures in large-scale investment. In the communication network, the efficiency of the rectifier to convert AC power into DC power is very important. The increase of the conversion efficiency of the rectifier is helpful to reduce the carbon dioxide emission and make the positive impact on the environmental protection.

Generally, the rectifier includes a magnetic element. For example, the magnetic element is a power factor correction (PFC) inductor. The performance of the magnetic element contributes approximately 50% to the overall performance of the rectifier. However, the conventional magnetic element has bulky volume and low inductance. Consequently, the efficiency of the conventional magnetic element is not satisfied.

Therefore, it is important to provide an improved magnetic element in order to overcome the drawbacks of the conventional technologies.

### SUMMARY OF THE INVENTION

An object of the present disclosure provides a magnetic element with reduced volume, increased inductance and enhanced efficiency.

In accordance with an aspect of the present disclosure, a magnetic element is provided. The magnetic element includes a first magnetic core, a coil and a second magnetic core. The first magnetic core is made of a ferrite material, and a magnetic permeability of the first magnetic core is higher than 700. The coil is installed on the first magnetic core. The second magnetic core is formed by molding an alloy composition. In addition, the coil and at least a portion of the first magnetic core are covered by the second magnetic core.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a magnetic element according to an embodiment of the present disclosure;

FIG. 2 is a schematic perspective view illustrating a first magnetic core of the magnetic element shown in FIG. 1; and

FIG. 3 is a schematic perspective view illustrating the first magnetic core and a coil of the magnetic element shown in FIG. 1.

### DETAILED DESCRIPTION OF THE PREFERRED EMBODIMENT

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

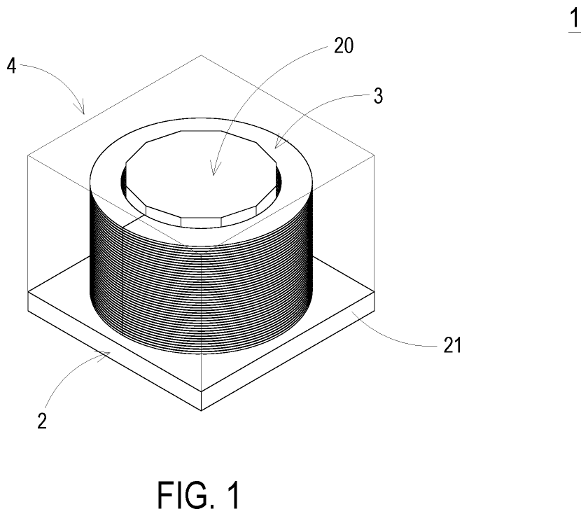

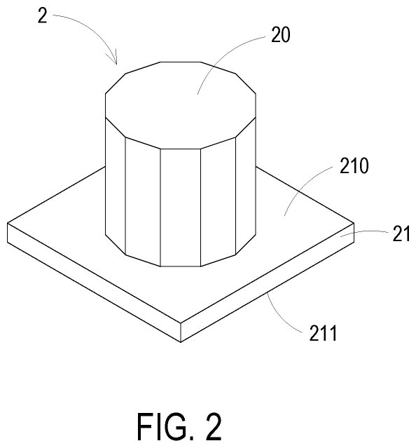

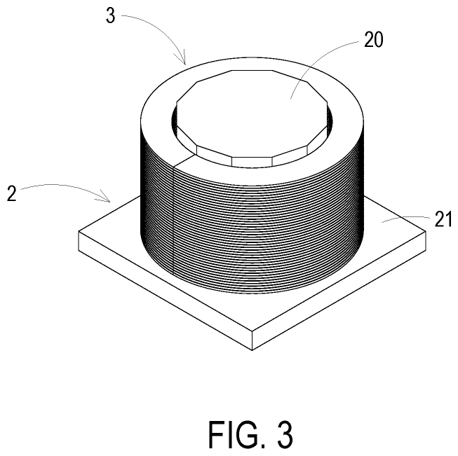

FIG. 1 is a schematic perspective view illustrating a magnetic element according to an embodiment of the present disclosure. FIG. 2 is a schematic perspective view illustrating a first magnetic core of the magnetic element shown in FIG. 1. FIG. 3 is a schematic perspective view illustrating the first magnetic core and a coil of the magnetic element shown in FIG. 1. In an embodiment, the magnetic element 1 is an inductor such as a power factor correction (PFC) inductor, but not limited thereto. As shown in FIGS. 1, 2 and 3, the magnetic element 1 includes a first magnetic core 2, a coil 3 and a second magnetic core 4.

The first magnetic core 2 is made of a ferrite material. The magnetic permeability of the first magnetic core 2 is higher than 700. The coil 3 is installed on the first magnetic core 2. The second magnetic core 4 is made of an alloy composition. The alloy composition includes an alloy powder and a gluing material. Particularly, the second magnetic core 4 is formed by molding the alloy composition. Preferably but not exclusively, the second magnetic core 4 has a rectangular shape. In addition, the coil 3 and at least a portion of the first magnetic core 2 are covered by the second magnetic core 4.

As mentioned above, the first magnetic core 2 is made of the ferrite material, and the second magnetic core 4 is formed by molding the alloy composition. Further, the magnetic permeability of the first magnetic core 2 is higher than 700. Consequently, in case that the inductance of the magnetic element 1 is substantially equal to the inductance of a conventional magnetic element, the turn number of the coil 3 of the magnetic element 1 is reduced. Due to this design, the volume of the magnetic element 1 is 20% less than that of the conventional magnetic element. In addition, the inductance of the magnetic element 1 is higher than that of the conventional magnetic element. For example, the inductance of the magnetic element 1 reaches 600 μH. Moreover, since the second magnetic core 4 is formed by molding the alloy composition, the shape of the second magnetic core 4 may be adjusted according to the requirements of the practical product. Consequently, the use flexibility of the magnetic element 1 is enhanced.

In some embodiments, the first magnetic core 2 is a T-Type ferrite core, and includes a winding part 20 and a base plate 21. The coil 3 is wound around the winding part 20. Preferably, the winding part 20 and the base plate 21 are integrally formed as a one-piece structure. In an embodiment, the winding part 20 has a cylindrical shape or a polygonal shape, and the base plate 21 has a rectangular shape. The shapes of the winding part 20 and the base plate 21 may be varied according to the practical requirements. The base plate 21 includes a top surface 210 and a bottom surface 211, which are opposed to each other. The winding part 20 is protruded from the top surface 210 of the base plate 21. In an embodiment, the coil 3, the top surface 210 of the base plate 21 and the winding part 20 are covered by the second magnetic core 4. It is noted that numerous modifications and alterations may be made while retaining the teachings of the invention. For example, in another embodiment, the coil 3, the top surface 210 of the base plate 21, the bottom surface 211 of the base plate 21 and the winding part 20 are covered by the second magnetic core 4.

In some embodiments, the coil 3 is an air coil. The coil 3 can be wound around the winding part 20 of the first magnetic core 2 by using an automatic winding process. When compared with the method of manually winding the coil of the conventional magnetic element, the method of automatically winding the coil 3 of the magnetic element 1 provides the enhanced winding performance. Further, the inductance of the magnetic element 1 is increased, and the inductance quality of the magnetic element 1 is enhanced. In some embodiments, the coil 3 is a copper wire. After the coil 3 is wound around the winding part 20, the outlet terminal of the coil 3 can be drawn out from a lateral side of the base plate 21. Then, the second magnetic core 4 is formed by molding the alloy composition to cover the coil 3 and at least a portion of the first magnetic core 2. In addition, the magnetic element 1 of the present disclosure may be designed to be operated at high frequency (e.g., 300 kHz). Accordingly, in some embodiments, the coil 3 can be a printed wiring board (PWB).

In some embodiments, the magnetic permeability of the second magnetic core 4 is lower than 125. As mentioned above, the second magnetic core 4 is made of the alloy composition. Preferably, the alloy composition includes no plastic material. In other words, the alloy composition includes the alloy powder and the gluing material only. The alloy powder includes iron and other metal. For example, the alloy powder is iron silicon aluminum powder, manganese zinc iron powder or nickel zinc iron powder, and the gluing material is made of epoxy, acrylate, polyurethane.

From the above descriptions, the present disclosure provides a magnetic element. The magnetic element includes a first magnetic core, a coil and a second magnetic core. The first magnetic core is made of a ferrite material. The second magnetic core is formed by molding an alloy material. A magnetic permeability of the first magnetic core is higher than 700. Due to this design, the volume of the magnetic element is 20% less than that of the conventional magnetic element, and the inductance of the magnetic element reaches 600 μH. Moreover, since the second magnetic core is formed by molding the alloy composition, the shape of the second magnetic core may be adjusted according to the requirements of the practical product. Consequently, the use flexibility of the magnetic element is enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A magnetic element, comprising:
a first magnetic core made of a ferrite material, wherein a magnetic permeability of the first magnetic core is higher than 700;
a coil installed on the first magnetic core; and
a second magnetic core formed by molding an alloy composition, wherein the coil and at least a portion of the first magnetic core are covered by the second magnetic core.

2. The magnetic element according to claim 1, wherein a magnetic permeability of the second magnetic core is lower than 125.

3. The magnetic element according to claim 1, wherein the alloy composition includes no plastic material.

4. The magnetic element according to claim 1, wherein the alloy composition includes an alloy powder and a gluing material.

5. The magnetic element according to claim 1, wherein the first magnetic core comprises a winding part and a base plate, wherein the winding part is protruded from the base plate, the winding part and the base plate are integrally formed as a one-piece structure, and the coil is wound around the winding part.

6. The magnetic element according to claim 5, wherein the base plate comprises a top surface and a bottom surface, wherein the top surface and the bottom surface are opposed to each other, the winding part is protruded from the top surface of the base plate, and the coil, the top surface of the base plate and the winding part are covered by the second magnetic core.

7. The magnetic element according to claim 1, wherein the coil is a copper wire.

8. The magnetic element according to claim 1, wherein the magnetic element is operatable at a high frequency of 300 kHz, and the coil is a printed wiring board.

9. The magnetic element according to claim 1, wherein the magnetic element is an inductor.

10. The magnetic element according to claim 1, wherein an inductance of the magnetic element reaches 600 μH.
